(19) United States
(12) Patent Application Publication
(10) Pub. No.: US 2009/0320774 A1
(43) Pub. Date: Dec. 31, 2009

(54) OPERATING METHOD FOR AN INTERNAL COMBUSTION ENGINE WHICH CAN BE SELECTIVELY OPERATED BY MEANS OF A LIQUID FUEL AND A GASEOUS FUEL, AND FUEL SUPPLY SYSTEM

(76) Inventors: Stephan Liebsch, Hormersdorf (DE); Iraklis Avramopoulos, Stahnsdorf (DE)

Correspondence Address: Novak Druce & Quigg LLP, 1300 I Street NW, Suite 1000 West Tower, Washington, DC, 20005, US

(21) Appl. No.: 12/516,916

(22) PCT Filed: Nov. 22, 2007
(86) PCT No.: PCT/EP2007/010111

§ 371 Date: May 29, 2009

(30) Foreign Application Priority Data
Nov. 29, 2006 (DE) 10 2006 056 389.1

(51) Int. Cl. F01P 3/00; F02B 13/00

(52) U.S. Cl. 123/41.42; 123/575

(57) ABSTRACT

The invention relates to an operating method for an internal combustion engine which can be selectively operated by means of a liquid and a second fuel, in particular a gaseous fuel, wherein in operation of the internal combustion engine with the second fuel, in particular in the gas-operating mode, at least one temperature-loaded component of the internal combustion engine is cooled with the liquid fuel. The invention also relates to a fuel supply system for an internal combustion engine which can be operated by means of liquid and gaseous fuels.

The invention relates to an operating method for an internal combustion engine which can be selectively operated by means of a liquid fuel and a gaseous fuel, and a fuel supply system for such an internal combustion engine.

### BACKGROUND OF THE INVENTION

DE 195 39 170 A1 discloses such an operating method. The internal combustion engine can be selectively operated with gasoline or natural gas.

Moreover, DE 203 09 001 U1 discloses an injection valve for liquid and gaseous fuels.

Furthermore, DE 198 47 388 A1 discloses a fuel injection system which has injection nozzles which can be cooled by fuel. Operation exclusively with liquid fuels is possible. The injection nozzles are cooled preferably by flowing fuel which flows through the injection nozzle. A volumetric fuel flow which is controlled as a function of engine operating parameters flows around the forward region of the injection nozzle. The flowing fuel causes induced convection, as a result of which heat transfer from the injection nozzle to the flowing fuel which is used as a coolant can take place.

Moreover, it is known that gas and gasoline can be supplied at the same time, for example, by way of their own means for delivery into the mixture to be intaken or into the combustion chamber. In gas operation overheating of the injection nozzles for gasoline can occur. Moreover, in certain operating states of the engine, to reduce the exhaust gas temperature, more gas must be supplied than is stoichiometrically necessary.

This results in relatively high gas consumption in operating ranges in which the exhaust gas temperature must be reduced. Moreover, damage to components, in particular the injection nozzles for direct injection of gasoline, can occur.

Therefore, the object of this invention is to devise an operating method and a fuel supply system with which an internal combustion engine can be selectively operated by means of liquid and gaseous fuel and a more effective and more efficient operating method can be enabled.

### SUMMARY OF THE INVENTION

An operating method according to the invention enables selective operation of an internal combustion engine with liquid fuel and at least one other, second fuel. In operation of the internal combustion engine with the second fuel, at least one temperature-loaded component of the internal combustion engine is cooled with the liquid fuel. This procedure can enable a more energy-efficient and more effective operating method of such an internal combustion engine.

Preferably the second fuel is gaseous, in particular natural gas. In particular, gas consumption can be reduced in operating ranges in which the exhaust gas temperature must be reduced. To reduce the exhaust gas temperature, not nearly as much gaseous fuel need be supplied any longer and, moreover, the cooling action can be increased by cooling with liquid fuel. The cooling action of the liquid fuel, in particular gasoline, is higher as a result of the available evaporation enthalpy, compared to a gaseous fuel, in particular natural gas. Moreover, in particular in this gas operation, overheating of critical components, such as, for example, the means for supplying liquid fuel, can be prevented.

Supply of the liquid fuel to the component to be cooled is carried out depending on the temperature of this component. Thus, corresponding cooling with the liquid fuel can be carried out depending on the situation and with a high degree of precision. Only when a critical temperature is reached or exceeded do cooling with the liquid fuel and the corresponding supply take place. Efficiency and effectiveness can be increased in this way. Moreover, fuel can also be saved thereby.

Preferably the amount of liquid fuel is supplied depending on the temperature of the component to be cooled. Highly effective cooling thus can also be achieved since only as much liquid fuel is supplied for cooling as is actually necessary.

If the temperature of the component is not measured, the cooling fuel can be metered by suitable means for control and adjustment, for example, by characteristic values, characteristic curves, and characteristic maps in an engine control device such that sufficient cooling of the component is ensured using the available operating parameters.

Preferably, the liquid fuel for cooling is supplied to the component to be cooled until a threshold value temperature of the component is reached or it drops.

Preferably cooling of the component with the liquid fuel is done after the process of gas combustion in the expansion phase. The liquid fuel can preferably by delivered into regions of the combustion chamber of the internal combustion engine in which combustion is completed.

In certain situations of engine operation, for example, when the air consumption of the engine is to be increased by the cooling action of the liquid fuel or the air demand is to be reduced by supplying fuel with a lower minimum air demand, cooling of the components is carried out preferably in the intake phase of the engine.

Cooling of the component with the liquid fuel is preferably carried out in the combustion chamber in the state in which particle formation is no longer possible.

Preferably, the liquid fuel flows around or through the component to be cooled outside and/or inside for cooling. Here optimized cooling can be achieved as a function of demand.

It can also be provided that at least one fuel is supplied by way of supply means directly into the combustion chamber and another fuel, by way of additional supply means inside or outside the combustion chamber, for cooling. At least one of the fuels, in particular both fuels, are liquid. Likewise a single identical fuel can be metered by way of at least two different supply means and supplied for cooling.

If the two fuels are liquid, one can be, for example, conventional gasoline or diesel and the second liquid fuel can be a liquid biofuel, for example, rapeseed oil or sunflower oil, or also ethanol.

The liquid fuel is injected, in particular directly injected, for cooling of the component.

Preferably, an injection nozzle for liquid fuel is cooled as the component to be cooled. The injection nozzle can be designed exclusively for direct injection of the liquid fuel. But it can also be designed for injection of liquid and gaseous fuels into the combustion chamber of an internal combustion engine. Liquid fuels can be all those which are suitable for gasoline or diesel engine combustion processes. The gaseous fuel, in particular, is natural gas.

It can also be provided that the fuels are injected at the same time and that corresponding means for control and adjustment of this simultaneous injection are made. The cooling of the component can take place even without explicit measurement of the temperature of the component and supply of the liquid fuel which is dependent thereon, and can be carried out, in particular, by control and adjustment means.

In a fuel supply system according to the invention for an internal combustion engine which can be selectively operated by means of a liquid and another fuel, in particular gaseous fuels, a component of the internal combustion engine which is temperature-loaded in operation with the second fuel, in particular in gas operation, can be cooled with the liquid fuel. The mode of operation can take place energy-optimized and highly efficiently. Overheating and the resulting component damage, in particular of a direct gasoline injection nozzle, can thus be prevented.

Means for control and adjustment are designed preferably for simultaneous injection of fuels.

Advantageous embodiments of the operating method according to the invention can be regarded as advantageous embodiments of the fuel supply system according to the invention.

One exemplary embodiment of the invention is detailed below.

### DETAILED DESCRIPTION OF AN EMBODIMENT OF THE INVENTION

A vehicle with an internal combustion engine which can be selectively operated by means of liquid and gaseous fuel can be switched between different operating modes. This can take place depending on the instantaneous loading state of the internal combustion engine. In particular, the internal combustion engine can be operated with gasoline as the liquid fuel and natural gas as the gaseous fuel.

If there is a transition from gasoline operation into gas operation, at least one temperature-loaded component of the internal combustion engine, in this exemplary embodiment a direct gasoline injection nozzle for liquid fuel, is cooled. This takes place by its being generally decided depending on the temperature of the component whether a liquid fuel, in particular gasoline, is supplied to this temperature-loaded component or not. If such a temperature range is reached, gasoline is routed to this injection nozzle and it is cooled by the gasoline flowing through or around the injection nozzle from the outside and/or inside.

The amount which is routed to this injection nozzle for cooling is dependent on the temperature of the injection nozzle to be cooled. Metering can also take place to the degree with which overheating of other components of the drive line can be avoided.

The cooling of the components with gasoline is carried out especially after the process of gas combustion in the expansion phase. Moreover, cooling takes place with the liquid fuel at temperatures which are below the temperature at which particle formation occurs.

The operating process and the fuel injection system enable significantly increased component protection and lower gas consumption with an only moderate rise of gasoline consumption. In this way advantageous fuel use and an increase in vehicle range in gas operation can be achieved.

1. An operating method for an internal combustion engine which can be selectively operated by means of a liquid fuel and another, second fuel wherein in operation of the internal combustion engine with the second fuel, at least one temperature-loaded component of the internal combustion engine is cooled with the liquid fuel.

2. The operating method according to claim 1 wherein the liquid fuel to the component to be cooled is carried out depending on the temperature of this component.

3. The operating method according to claim 1 wherein the amount of liquid fuel is supplied depending on the temperature of the component to be cooled.

4. The operating method according to claim 1 wherein the liquid fuel for cooling is supplied to the component to be cooled until a threshold value temperature of the component is reached or it drops.

5. The operating method according to claim 1 wherein the second fuel is gaseous and in gas operation of the internal combustion engine the cooling of the temperature-loaded component is done with the liquid fuel.

6. The operating method according to claim 5 wherein cooling of the component with the liquid fuel is done after the process of gas combustion in the expansion phase.

7. The operating method according to claim 1 wherein the instant of cooling is chosen such that no particle formation occurs in the combustion chamber by cooling of the component.

8. The operating method according to one claim 1 wherein at least one liquid fuel flows around or through the component to be cooled outside and/or inside for cooling.

9. The operating method according to claim 1 wherein the liquid fuel is injected: for cooling of the component.

10. The operating method according to claim 1 wherein an injection nozzle for liquid fuel is cooled as the component.

11. The operating method according to claim 1 wherein a liquid fuel is supplied by way of supply means inside or outside of the combustion chamber for cooling and at least one other fuel; is supplied by way of supply means directly into the combustion chamber of the internal combustion engine.

12. The operating method according to claim 1 wherein a liquid fuel is metered by way of at least two different supply means.

13. A fuel supply system for an internal combustion engine which can be selectively operated by means of a liquid and another second fuel wherein in operation of the internal combustion engine with the second fuel a temperature-loaded component of the internal combustion engine can be cooled with the liquid fuel.

14. The fuel supply system according to claim 13 including means for control and adjustment of simultaneous injection of the fuels.

15. A method of operating an internal combustion engine fueled by at least one of first and second fuels, comprising disposing one of said fuels in heat transfer relation with the other of said fuels as said other fuel is supplied to said engine.

16. A method according to claim 15 wherein said one fuel is disposed in heat transfer relation with a component containing said other fuel.

17. A method according to claim 15 wherein said one fuel is supplied to said other fuel.

18. A method according to claim 15 wherein said one fuel comprises a liquid fuel and said other fuel comprises a gaseous fuel.

19. A system for supplying fuel to an internal combustion engine comprising;
means for selectively supplying one of a first fuel, a second fuel and both said first and second fuels to said engine; and
means for supplying one of said first fuel and second fuels in heat transfer relation with said second fuel when said second fuel is supplied to said engine.

20. A system according to claim 19 wherein said first fuel is a liquid fuel and said second fuel is a gaseous fuel.
